(19) United States
(12) Patent Application Publication
(10) Pub. No.: US 2026/0330537 A1
(43) Pub. Date: Oct. 22, 2026

(54) PRODUCT AS A KEY FOR CONTEXT-BASED IMAGE GENERATION

(71) Applicant: Zazzle Inc., Menlo Park, CA (US)

(72) Inventors: Matthew DIFONZO, Belmont, CA (US); Leslie Young HARVILL, Menlo Park, CA (US)

(21) Appl. No.: 19/715,635

(22) Filed: Jun. 22, 2026

Related U.S. Application Data
(63) Continuation of application No. 18/219,527, filed on Jul. 7, 2023, now Pat. No. 12,675,818.

(51) Int. Cl. G06Q 30/0601; G06T 11/60

(52) U.S. Cl. CPC G06Q 30/0643; G06Q 30/0621; G06T 11/60; G06T 2210/16

(57) ABSTRACT

In some embodiments, a method for using a custom product as a key for context-based image generation comprises: receiving, by a visualization service of a computer collaboration system, a graphical representation of a custom digital product; determining one or more regions for customizing regions; for a region of the regions: determining a set of phrases that are specific to the custom digital product; based on the set of phrases, generating a synthetic image generation request; transmitting request to an AI based image generator configured to generate synthetic images; causing the AI-based generator to: generate a customized synthetic image based on the request and a repository of images; transmit the customized synthetic image to the computer collaboration system; including the image in the region; causing displaying the graphical visualization of the custom digital product along with the customized synthetic image in the region.

### CROSS-REFERENCE TO RELATED APPLICATIONS

This application is a continuation of U.S. patent application Ser. No. 18/219,527, filed on Jul. 7, 2023, which is herein incorporated by reference.

### FIELD OF THE DISCLOSURE

One technical field of the present disclosure is digital image processing. Another technical field is computer-implemented techniques for generating synthetic digital images based on requests derived from various sources, including customized digital content, customization characteristics, user profiles, and the like. Another technical field is computer-implemented techniques for merging generated digital synthetic images with customized content using digital image processing, and for producing accurate, near-real-time depictions of customizable items blended with the generated synthetic images.

### BACKGROUND

The approaches described in this section are those that could be pursued but are not necessarily ones that have been previously conceived or pursued. Therefore, unless otherwise indicated, it should not be assumed that any of the approaches described in this section qualify as prior art merely by their inclusion in this section.

With the growth of digital computing capabilities and enhancements in manufacturing processes, goods manufacturing is transforming to produce goods according to individual customer requests received from customers' computers. This may include, for example, fulfilling online orders from customers who use their computer systems to customize generic goods and place orders for individually customized goods.

Many systems on the market are configured to allow users to order products with customized attributes. For example, for custom-manufactured framed products such as photos, digital images, artwork, and other items, the systems may allow users to order frames in customized sizes and colors.

Customizing products with many parameters can be quite challenging. The selection of customization values may affect the appearance and rendering of the final custom products. Therefore, the systems often provide functionality to display depictions (e.g., synthetic views) of the customized products, help users visualize them before ordering.

However, current systems typically use stock images as backgrounds when displaying customized products. The stock images are usually prepared in advance and selected to display the customized product in a predictable, unchangeable way. Furthermore, in some situations, the stock images are rarely related to the actual product that users are customizing and ordering. Moreover, stock images rarely enhance the users'experience as users customize and inspect digital depictions of the customized products displayed on computer-based devices.

Therefore, there is a need to generate and render synthetic backgrounds and visual components to efficiently and contemporaneously visualize custom products during the product customization process. There is a need to generate synthetic backgrounds and visual components based on information specific to the customized product and to the users who perform the customization. Furthermore, there is a need to generate such synthetic images on the fly, quickly enough to avoid delays in rendering the resulting customized products superimposed on the synthetic background images, and the like. The rendering time for a frame in a real-time rendering application should be low, as latency is a key barrier to supporting user interactions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a block diagram showing an example environment for using a product as a key for context-based image generation;

FIG. 1B is an example of options and processing byproducts;

FIG. 1C is an example of options and processing byproducts;

FIG. 1D is an example of customization;

FIG. 1E is an example of customization;

FIG. 1F is an example of customization;

FIG. 1G is an example of customization;

FIG. 1H is an example of customization;

FIG. 1I is an example of obtaining a base image;

FIG. 2A is an example of utilizing an AI-based image generation approach;

FIG. 2B is an example of an AI input and a corresponding AI output to be merged with a customized image;

FIG. 3A is a block diagram showing an example environment for designing and manufacturing products;

FIG. 3B is a block diagram showing an example of a role-based collaboration platform;

FIG. 4 is a flow chart depicting an example process for using a product as a key for context-based image generation;

FIG. 5 is a block diagram that illustrates a computer system with which the techniques herein may be implemented.

### DESCRIPTION OF EXAMPLE EMBODIMENTS

In the following description, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

Embodiments are described herein according to the following outline:
1. GENERAL OVERVIEW
2. GENERATING SYNTHETIC BACKGROUNDS AND IMAGES
2.1. COMPUTATIONAL ENVIRONMENT
2.2. SYNTHESIZED BACKGROUNDS AND IMAGES
2.3. STABLE DIFFUSION
3. SELECTING CONTENT FOR GENERATING REQUESTS
4. EXAMPLE REQUESTS
5. BASE IMAGES
6. GENERATING SYNTHETIC BACKGROUNDS/IMAGES USING AI
6.1. REQUESTS
6.2. AI-BASED IMAGE GENERATOR
6.3. SYNTHETIC IMAGES
7. EXAMPLE MANUFACTURING SYSTEM
7.1. STRUCTURAL DESCRIPTION OF AUTHORING TOOL
7.2. DESIGNING AN ASSET
7.3. ASSET DEFINITION DATA
7.4. USER DEVICES
7.5. CLIENT APPLICATIONS
7.6. FRONTEND SERVERS
7.7. CORE SERVICES
7.8. EXAMPLE MANUFACTURING SYSTEM
7.9. EXAMPLE MANUFACTURING PROCESS
8. EXAMPLE PRODUCT COLLABORATION PLATFORM
9. EXAMPLE FLOW CHART
10. IMPLEMENTATION MECHANISMS

### 1. General Overview

The disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

Artificial Intelligence (AI) and AI-based tools offer tremendous potential for image generation and customization. For example, AI-based tools may generate synthetic images and deliver a great user experience, along with a wealth of new capabilities for otherwise difficult and mundane work.

One of the AI-based approaches can be utilized to produce imagery for product customization, for example, in online shopping digital customization. This may include guiding a user through creating and generating on-the-fly backgrounds and other images to enhance the customization of digital products. The on-the-fly-generated backgrounds and other images may be customized in various ways, including matching them to the customized product, as described later.

One unique aspect of the presented approach is that backgrounds and images are generated on the fly from a large repository of publicly available images, using the provided keywords, terms, descriptions, and the like. The on-the-fly-generated images are not the actual images included in the repository. Instead, the on-the-fly-generated images are uniquely synthesized from the images stored in the repository. The algorithms for generating or synthesizing on-the-fly AI-based images are described later.

Suppose that a customized product is a Christmas tree decoration. A corresponding on-the-fly-generated background may be a Christmas-themed scene that matches the customized product in terms of the occasion, the color scheme, and the like. The on-the-fly-generated background may be synthesized from a large set of Christmas-related images stored in the repository. Such an AI-generated background may be included in, for example, a 3D visualization/depiction of the custom product, such as a Christmas tree decoration. As the product is further customized, for example by changing its color, a new background may be generated on the fly to match the customized product's color scheme.

As another example, suppose a customized product is a tote, and the customization includes designing a colorful application insert for the tote's front. A textual description of the desired colorful application can be used to generate an on-the-fly image for the tote insert. If the description of the desired application includes, for example, the words “spring flowers in Paris,” then the corresponding on-the-fly-generated image may be drawn from a large set of pictures depicting flowers in Paris. The resulting synthesized image may depict flowers blooming in a park in Paris, or the like.

There may be situations where several on-the-fly-generated backgrounds and images are generated for a custom product. The backgrounds and images may be superimposed or otherwise included in the depiction of the custom product. Including such synthesized backgrounds and images allows for enhanced product customization and presentation quality.

In some situations, on-the-fly-generated backgrounds and images are part of a product description. The description may also include information about the UV markup area, which is defined by field markup, digital markup, yellow grids, inverted yellow grids, mesh deformation, masks, and other methods. If, for example, the description includes a UV markup area within a customized product, then an on-the-fly-generated image may be applied to the area defined by the UV markup.

For another example, if the description includes a masked area, an on-the-fly-generated background may be applied to that area. The mask may be used to delineate the region in which, for example, a background can be replaced with an AI-generated image.

### 2. Generating Synthetic Backgrounds and Images

### 2.1. Computational Environment

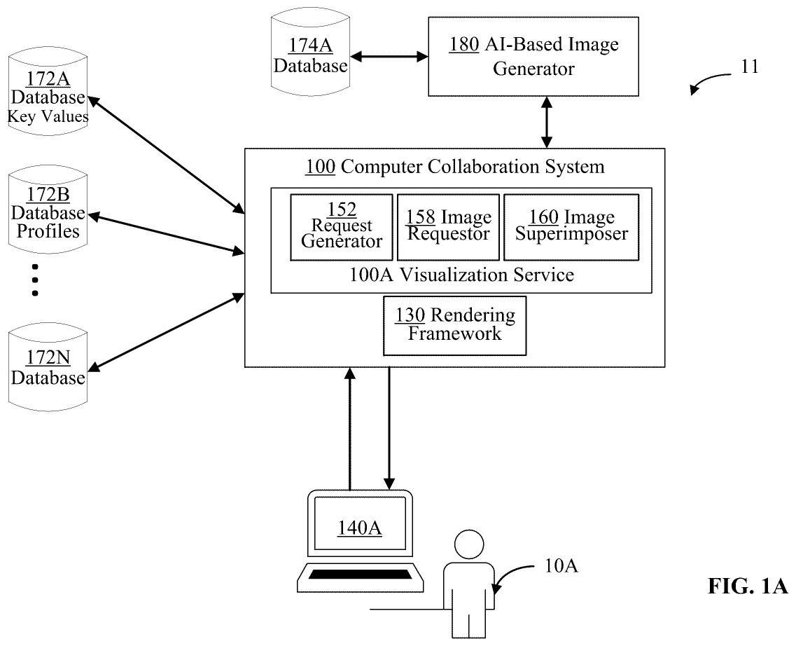

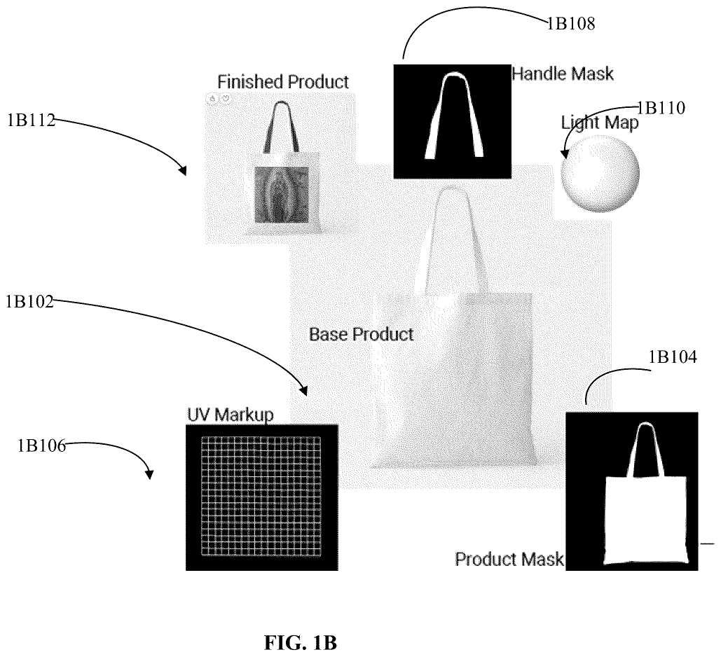

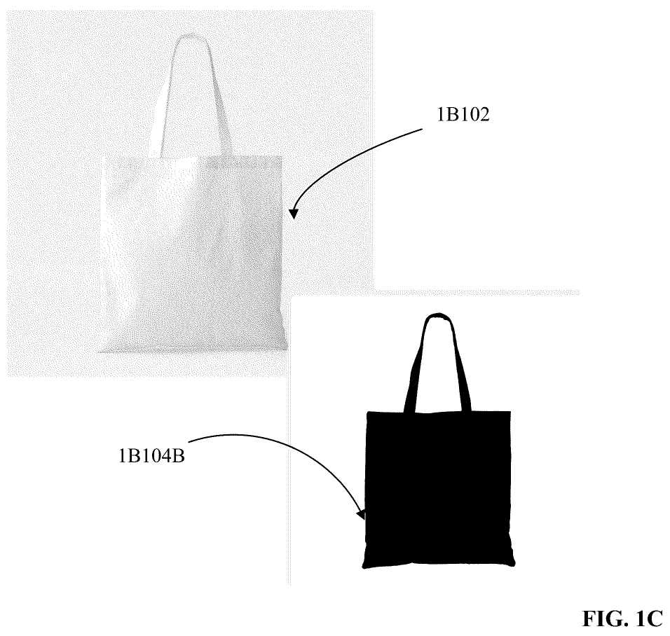

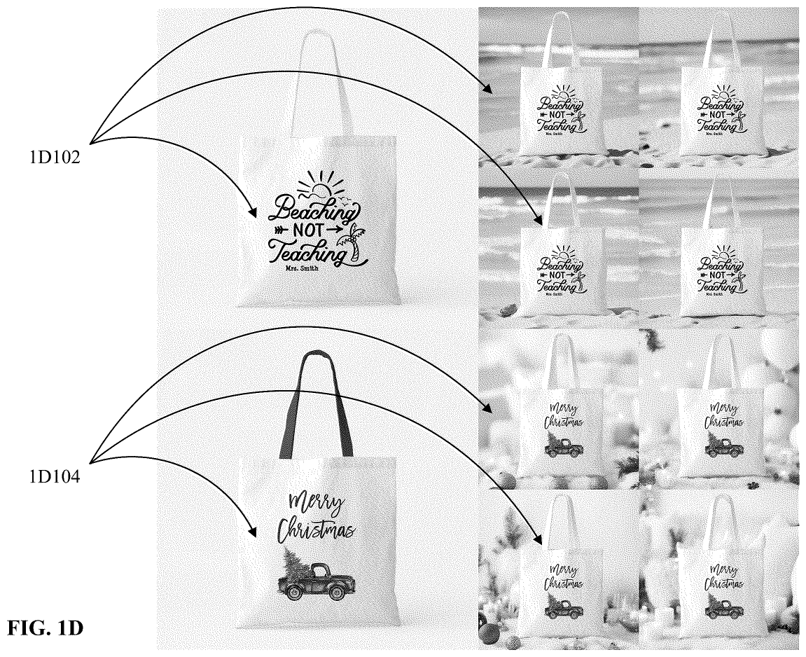

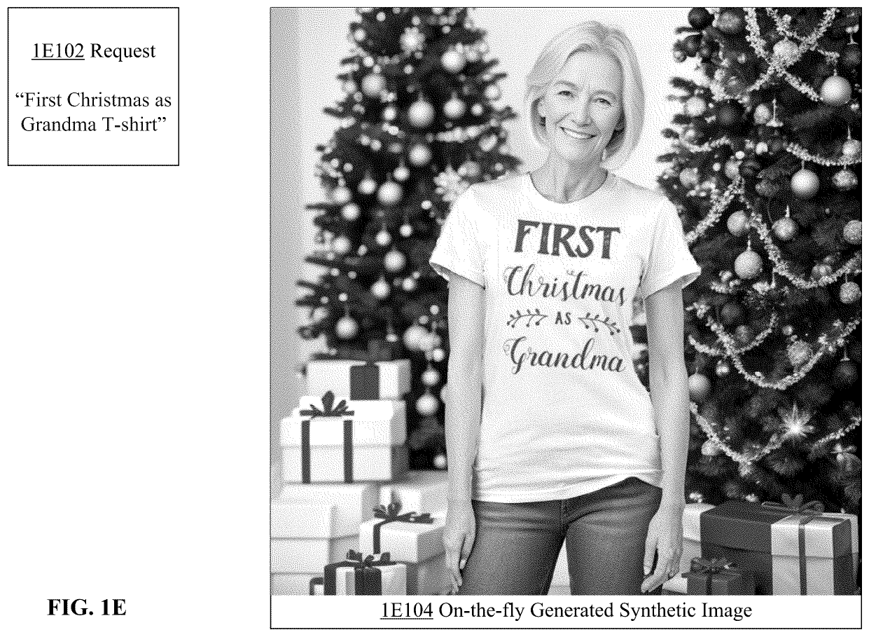

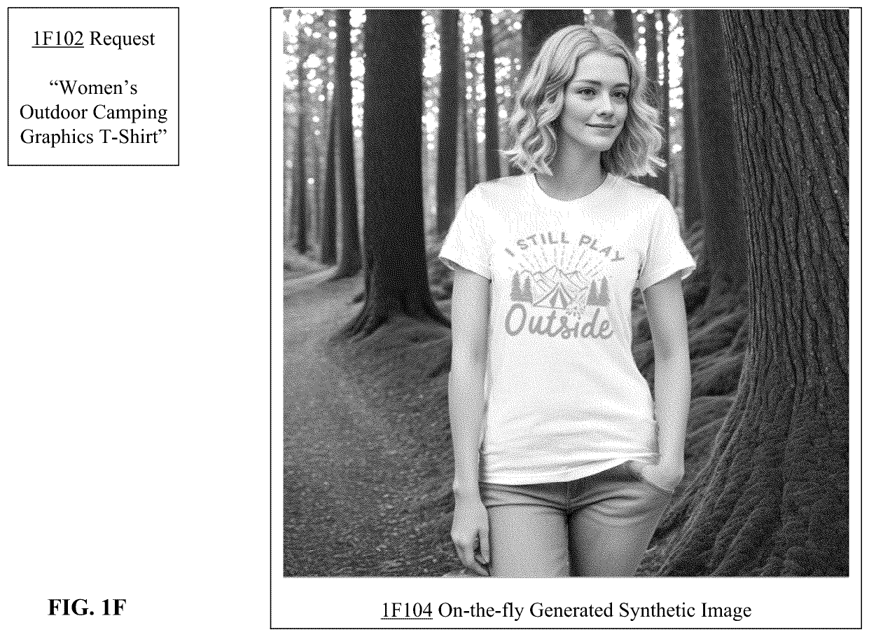

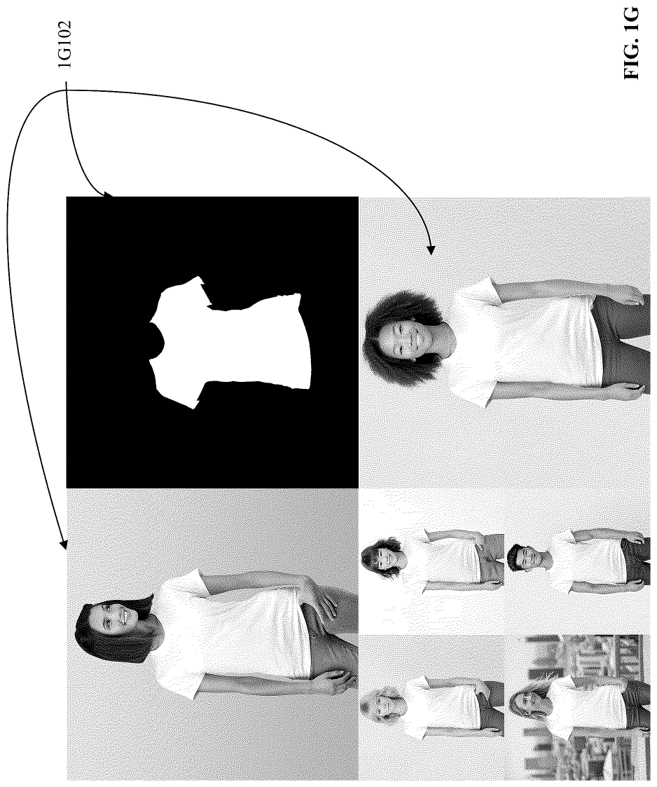

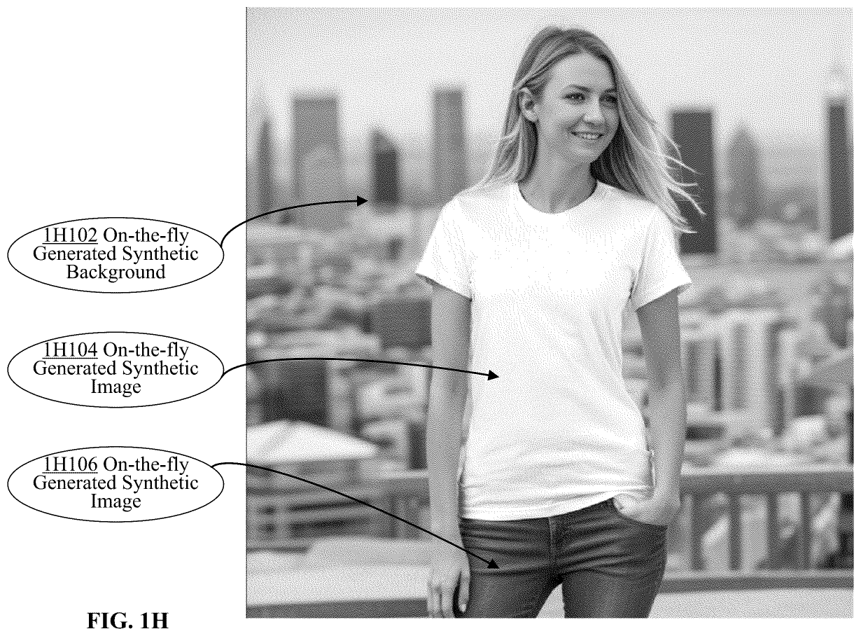

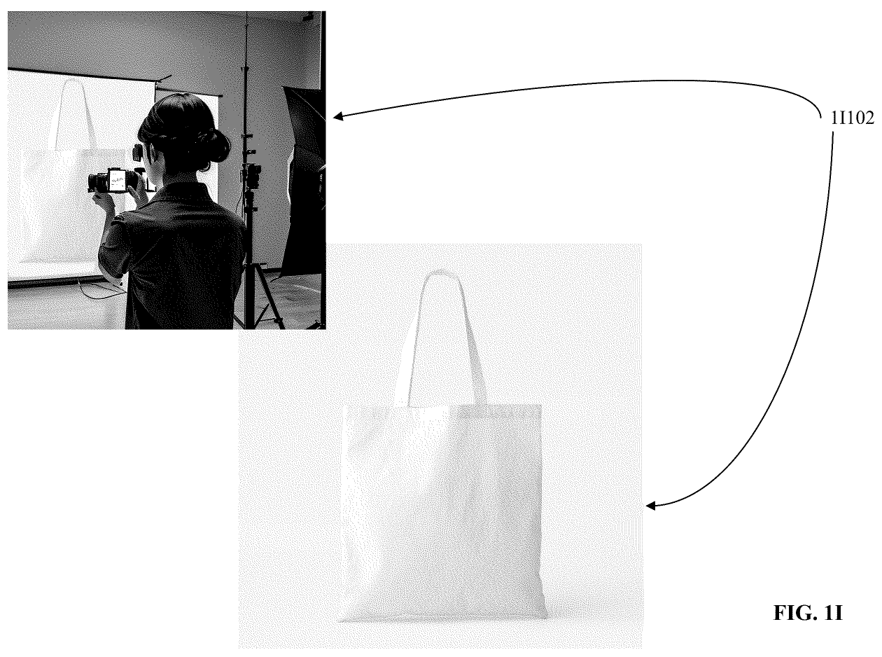

FIG. 1 is a block diagram showing an example environment 100A for using a product as a key for context-based image generation. FIG. 1, the other drawing figures, and all of the descriptions and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

An example of an environment 11 depicted in FIG. 1A is configured to use a product as a key for context-based image generation. One of the elements of environment 11 is a computer collaboration system 100, which is described in detail later. For the clarity of the description, computer collaboration system 100 comprises a visualization service 100A, which in turn comprises a request generator 152, an image requestor 158, an image superimposer 160, and a rendering framework 130 (described in detail later). All these components are described in detail later.

Collaboration system 100 may also include other components, examples of which are described later.

In some implementations, environment 11 also includes a database 172A storing key-value pairs (described later), a database 172B storing user profiles (described later), and one or more other databases 172N for storing additional information used by various components of environment 11 and/or computer collaboration system 100.

Environment 11 may also include a database 174A for storing, e.g., billions of publicly available digital images. Such images may be downloaded from public resources, databases, and other repositories. For example, the images may be downloaded from the Internet and may represent part of the DALL-E system (described later).

Images stored in database 174A or in other storage included in environment 11 may be used by an AI-based image generator 180. AI-based image generator 180 may be an AI-based application configured, for example, to implement the Stable Diffusion approach to generate or synthesize images in response to a textual query.

### 2.2. Synthesized Backgrounds and Images

AI-based techniques used in this approach may include various generative AI (GAI) methods. An example of such a technique is Stable Diffusion (SD). In this context, SD may be used to generate a digital image context for a custom product without altering the custom product itself or changing a key that refers back to the product database version of the custom product. Examples of the SD techniques are briefly described later.

Suppose a custom product is a tote displayed on an online shopping website, allowing users to customize and order it digitally. The custom product (i.e., the tote here) can be customized in various ways. The customization may pertain, for example, to the tote's front side. An example of such a customization is described in FIG. 1B.

FIG. 1B is an example of options and processing byproducts. Suppose that a base image for the front side of the custom product (e.g., the tote) is plain cloth. However, to make the tote appear more attractive on an online shopping website's display, it might be desirable to replace the plain cloth front with an image that in some way corresponds to a user's interests, profile, and the like. Furthermore, to make the tote appear more attractive on the display, it might be desirable to replace the mono-color background with an attractive background, such as an image of a beach, traveling along the beach, playing on the beach, and the like. Such images and backgrounds may be generated on the fly using, for example, SD, which is described later.

To allow customization of a product, computer collaboration system 100 (described in FIG. 1A and later) may use one or more graphical representations of the product and several masks to select areas within a depiction of the product that can be customized and filled with synthesized AI-based images—several maps for implementing lighting models, light reflections, and the like. The representations, masks, and maps are typically used to make product depictions more attractive, realistic, and better aligned with users'interests.

FIG. 1B depicts a base product 1B102 (e.g., a tote), a few masks (e.g., a product mask 1B104, a UV markup 1B106, a handle mask 1B108), a light map 1B110, and a finished product 1B112. The depiction of base product 1B102 (a tote) shows a plain cloth tote. Product mask 1B104 is a binary mask that allows the tote's depiction to be distinguished from the background. This mask may be used, for example, to mask a depiction of the tote's background and to allow customization or beautification of the depiction of the tote itself. Alternatively, or as shown later in FIG. 1C, a product mask may be used to hide a depiction of the tote itself and to allow customization or beautification of the tote's background.

UV markup 1B106 is a grid used to map a synthesized AI-generated image onto the front of the tote. This mask may be used, for example, to define a region corresponding to the front side of the tote and to paste a synthesized AI-based image onto that region.

Handle mask 1B108 is a binary mask that allows distinguishing a depiction of the tote handle from a background of the tote handle. This mask may be used, for example, to mask the background of the tote's handle and define a region of the handle itself. That, in turn, will allow customizing the color of the tote's handle, and the like.

Light map 1B110 may be used to generate light-reflection characteristics for the final depiction of the custom product. This map may enable the generation of light reflections, shadows, diffuse light, and the like in the final depiction of the custom product.

Finished product 1B112 is an image in which (1) the front side of the tote includes a synthesized AI-based image depicting a colorful picture, (2) the handle of the tote is shown as a green handle, and (3) the entire depiction of the custom product has been illuminated using one or more light sources and using light map 1B110.

FIG. 1C is an example of an option and a processing byproduct. In comparison with FIG. 1B, FIG. 1C is a variation of FIG. 1B. More specifically, a new product mask 1B104B is a binary mask that allows distinguishing a depiction of the tote from the background of the tote; however, in mask 1B104B, the tote itself is masked using black color (black pixels), while the background of the tote is shown using white color (white pixels). Depending on the masking convention, the new product mask 1B104B may be used to mask (e.g., ignore) the tote itself, making the tote background available for applying a new image. Hence, the new mask 1B104B may be used to replace the tote's background with a synthesized AI-generated image.

Using the same masking convention, product mask 1B104 (from FIG. 1B) may be used to mask (e.g., ignore) the depiction of the tote's background and make available the tote's depiction itself for applying a new image. Hence, mask 1B104 may be used to replace the depiction of the tote itself with a synthesized AI-generated image.

In other implementations, the mask convention may be reversed; therefore, the masks may correspond to the reversed purposes, and thus the effects of their applications may be reversed.

To generate on-the-fly images using the described approach, first, a textual query may be generated. The query may include several keywords, phrases, or the like. The keywords/phrases may be determined based on a product description of a customized product, information extracted from a user's profile, a history of the searches performed by a user, and the like. This may also include defining the context for a customization process performed on the custom product, and then generating a combination of the context data and other keywords/phrases derived from other sources.

A textual query may be provided to a generative AI-based application, such as SD, which generates output that may include one or more images. SD may be guided by the input (i.e., the provided textual query) to synthesize images from various databases.

### 2.3. Stable Diffusion

While the present approach is not about inventing Stable Diffusion (SD), it uses the SD methodology as a tool to support its inventive aspects. Therefore, the disclosure herein includes a brief overview of SD technology.

SD is a deep learning text-to-image model that is primarily used to generate detailed images conditioned on text descriptions. The model may also be applied to other applications such as inpainting, outpainting, and the like. SD may also be used to generate image-to-image translations guided by a text prompt. Stability AI Inc. developed it in collaboration with several academic researchers and non-profit organizations.

SD is a latent diffusion model used in deep generative networks. The code and model weights used in the SD approach have been released and are in the public domain. Hardware requirements typically include a rather modest GPU with at least 8 GB of VRAM. Access to cloud services is not required (which differentiates SD from other text-to-image models such as DALL-E and Midjourney.

SD uses a latent diffusion model (LDM) developed by the CompVis group at LMU Munich. Generally, the diffusion models are trained with the objective of removing successive applications of Gaussian noise on training images, which can be thought of as a sequence of denoising autoencoders.

Usually, SD consists of three parts: a variational autoencoder (VAE), a U-Net, and an optional text encoder. The VAE encoder compresses the image from pixel space into a lower-dimensional latent space, capturing a more fundamental semantic representation. Gaussian noise is iteratively applied to the compressed latent representation during the forward diffusion.

The U-Net block, composed of a ResNet backbone, denoises the output from forward diffusion backward to obtain a latent representation.

The VAE decoder generates the final image by converting the representation back into pixel space.

The denoising step can be flexibly conditioned on a text string, an image, or another modality. The encoded conditioning data is exposed to denoising U-Nets via a cross-attention mechanism. For conditioning on text, the fixed, pre-trained CLIP ViT-L/14 text encoder is used to transform text prompts into an embedding space. The increased computational efficiency for training and generation is usually an advantage of LDMs.

SD is usually trained on image-caption pairs from LAION-5B, a publicly available dataset derived from Common Crawl data scraped from the web. Typically, 5 billion image-text pairs are used, classified by language and filtered into separate datasets by resolution, predicted likelihood of containing a watermark, and predicted aesthetic scores, such as subjective visual quality. The dataset was created by LAION, a German non-profit that receives funding from Stability AI.

The Stable Diffusion model was trained on three subsets of LAION-5B: laion2B-en, laion-high-resolution, and laion-aesthetics v2.5+. A third-party analysis of the model's training data identified that out of a smaller subset of 12 million images taken from the original wider dataset used, approximately 47% of the sample size of images came from 100 different domains, with Pinterest taking up 8.5% of the subset, followed by websites such as WordPress, Blogspot, Flickr, and the like. The model was trained using 256 NVIDIA A100 GPUs on Amazon Web Services for a total of 150,000 GPU-hours, costing $600,000.

Stable Diffusion may encounter degradation and inaccuracies in certain scenarios. Initial releases of the model were trained on a dataset consisting of 512×512-resolution images, meaning the quality of generated images noticeably degrades when user specifications deviate from the model's “expected” 512×512 resolution.

However, the version 2.0 update of the Stable Diffusion model later introduced the ability to generate images at 768×768 resolution, which helped overcome some of the above-mentioned issues.

Another challenge for Stable Diffusion is generating human limbs due to poor limb data quality in the LAION database. It appears that the model is insufficiently trained to understand human limbs and faces due to a lack of representative features in the database, which can confound it when prompted to generate such images.

Fine-tuned adaptations of Stable Diffusion, created through additional retraining, have been used for a variety of use cases, from medical imaging to algorithmically generated music. The fine-tuning process is, however, sensitive to the quality of new data; low-resolution images or different resolutions from the original data can not only fail to learn the new task but also degrade the model's overall performance. Even when the model is additionally trained on high-quality images, it may be difficult for individuals to run models on consumer electronics, such as Nvidia's GeForce 30 series, which has only about 12 GB of VRAM, whereas 30 GB is usually required.

To address the limitations of the model's initial training, end-users may opt to implement additional training to fine-tune generation outputs to match specific use cases better. There are three methods in which user-accessible fine-tuning can be applied to a Stable Diffusion model checkpoint: (1) an embedding, (2) a hypernetwork, and (3) a DreamBooth. The present approach leverages a handful of Low Rank Adaptation (LoRA) techniques to accentuate certain lighting models that fall outside the realm of typical Stable Diffusion processes when handling, for example, very light and/or very dark images. The LoRA techniques allow fine-tuning based on the prevalence of white and black in an image. Using these in conjunction with other lighting information allows achieving a more polished and vibrant look of the image generated using the generative process. Additional background information for these techniques is provided, for example, at https://huggingface.co/blog/lora and https://i.redd.it/well-researched-comparison-of-training-techniques-lora-v0-vl01e5grs6ca1.png?s=cfb3d4eb7d253025ffc68f6791740f7737604c84.

An “embedding” can be trained on a collection of user-provided images, allowing the model to generate visually similar images whenever the embedding name is used in a generation prompt. Embeddings are based on the “textual inversion” concept, in which vector representations of specific tokens produced by the model's text encoder are linked to new pseudo-words. Embeddings can be used to reduce biases within the original model or mimic visual styles.

A “hyper network” is a small pre-trained neural network that is applied to various points within a larger neural network. Hypernetworks steer results toward a particular direction, allowing Stable Diffusion-based models to imitate the art style of specific artists, even if the original model does not recognize those artists. They process the image by identifying key areas of interest, such as hair and eyes, and then patch these areas in the secondary latent space.

DreamBooth is a deep learning model that can be fine-tuned to produce precise, personalized outputs depicting a specific subject, following training on a set of images of that subject.

In the context of the approach presented herein, the SD approach utilizes the text-to-image model to generate detailed images conditioned on text descriptions.

### 3. Selecting Content for Generating Requests

There are several ways to generate requests to a GAI application to provide synthesized images. One way is to specify textual requests that include keywords and/or phrases indicating the theme or genre of the synthesized image. Other ways may include providing a sample image or images in the same or similar genre as the requested synthesized image. Other ways to request a specific synthesized image are also available.

A textual request for a synthesized, AI-generated image may be generated using many different approaches. According to one approach, keywords and phrases for the textual query may be generated based on the definition of a custom product.

By selecting keywords/phrases for a request (i.e., for a query) from the content of a product definition of the custom product. By doing so, the computer collaboration system (e.g., system 100 in FIG. 1A) does not change the product's actual definition. Instead, the system accesses the entire context, which in this case includes definitions of both the background and the custom product itself. Continuing with the tote's example above, this may allow accessing, removing, or modifying individual context of the objects shown in the depiction of the customized product, such as accessing, removing, or modifying the context for a tote, or a person holding the tote, a background of the tote's depiction, and the like.

Keywords/phrases for a textual request may be obtained from, for example, key-value pairs that are included in the product definition of the custom product. A key-value pair is a pair that captures a certain characteristic of the custom product, and each custom product may have hundreds, if not millions, of the associated key-value pairs. An example of a key-value pair is {color, red}, where “color” is the characteristic key and “red” is its value. Key-value pairs are described in detail later.

Keywords/phrases of a textual request may be viewed as a collection of different information that was extracted either from the product itself based on the key-value pairs or based on tags attached to the product.

Keywords/phrases may also be extracted from so-called associated data, including a set of key-values that allow the creation of the product, the association of the product with various groups, including social groups, and the like. For example, a custom product such as a tote may be associated with various social groups, such as a “trip to the beach” social group, a “family outing” social group, and the like.

Keywords/phrases in textual requests may also be edited based on information from associated events, user groups, event groups, and the like. For example, if a user's profile indicates that the user is a teacher and is planning a trip to Santa Cruz Beach, then the keywords/phrases for a corresponding textual request for synthesized AI-generated images may also include words such as beach, Ocean, sand, and the like.

FIG. 1D is an example of customization. In the depicted example, both the front and the background of a tote have been customized using synthesized AI-generated images. The upper part of FIG. 1D shows an example 1D102 of a customized tote and examples of customized backgrounds related to the beach theme. More specifically, the customized tote's front page shows “Beaching Not Teaching . . . ” and indicates that the backgrounds on which the tote is visualized feature a beach, sand, the ocean, and the like.

As another example, suppose a user's profile indicates that the user is sending invitations to many of her girlfriends for the Christmas Holidays. Then the keywords/phrases for a corresponding textual request for synthesized AI-generated images may also include words such as Merry Christmas, Christmas decorations, Christmas tree, and the like.

Referring again to FIG. 1D is an example 1D104 of customization. In the depicted example, both the front and the background of a tote have been customized using synthesized AI-generated images. The lower part of FIG. 1D shows a customized tote and customized backgrounds themed around Christmas. More specifically, the customized tote's front-page shows “Merry Christmas,” and the backgrounds used to visualize it feature Christmas, Christmas decorations, Christmas trees, and the like.

### 4. Example Requests

Keywords/phrases for textual requests may also be determined based on information about the attendees and the event's physical location. This type of information is usually a rich set associated with the product through key values, the product itself, the moment, or the central use to which the product is associated. That can also include a description of key values and structure around the Zazzle “moments” patents such as U.S. patent application Ser. Nos.: 18/120,403; 18/120,404; 18/120,405; 18/120,406; and 18/120,407.

Keywords/phrases for textual requests may also be determined based on the user's profile. For example, if a user's profile includes information about a race and/or gender of a user, then the race/gender information may be used as keywords for a textual request. Furthermore, if a user's profile includes their location, city, and the like, that information may be used as keywords in a textual request.

FIG. 1E is an example of customization. In the depicted example, the textual query 1E102 is “First Christmas as Grandma T-Shirt”, and the corresponding custom product shows a grandmother wearing a t-shirt with an application reading “First Christmas as Grandma.” The background for the depicted model and t-shirt includes a Christmas tree, holiday presents, and the like. All the images included in this depiction are synthesized AI-generated images obtained individually in response to the textual queries “First Christmas as Grandma” and “T-Shirt”.

FIG. 1F is an example of customization. In the depicted example, a textual query 1E102 is “Women's Outdoor Camping Graphics T-Shirt”, and the corresponding custom product shows a woman wearing a t-shirt with an application reading “I STILL PLAY Outside.” The background of the depicted model and t-shirt features a forest with trees, moss, and a dirt road. All the images included in this depiction are synthesized AI-based images obtained individually in response to submitting the textual query “Women's Outdoor Camping Graphics T-Shirt”.

FIG. 1G is an example of customization. In the depicted example, the model's face, gender, and background have been customized using synthesized AI-generated images. FIG. 1G shows example 1G102 of customized models and backgrounds used to depict a customized t-shirt. The different models include African-American women, Caucasian women, Hispanic women, Asian men, and the like. Some backgrounds depict a cityscape, assuming the user lives in a city. Each of the customization details, i.e., the model's faces, the model's bodies, the backgrounds, and the like, are synthesized AI-based images.

FIG. 1H is an example of customization and, more specifically, a detailed view of the lower-left example shown in FIG. 1G. FIG. 1H shows how different synthesized AI-based images may be included in a resulting depiction of a custom product. More specifically, FIG. 1H shows that the model's face, gender, and background have been customized using synthesized AI-generated images.

FIG. 1G shows customized models and backgrounds used to depict a customized t-shirt. More specifically, an on-the-fly-generated synthetic background, 1H102, is used as the model's background. An on-the-fly generated synthetic image 1H104 of the model is used to display a t-shirt. An on-the-fly-generated synthetic image 1H106 is shown as the jeans the model wears. Of course, the models may be changed on the fly by modifying the textual request to match, for example, African-American, Caucasian, Hispanic, or Asian women, or men. Similarly, the backgrounds can be changed on the fly by modifying the textual request to match, for example, other cities, rural areas, beaches, and the like. Backgrounds depict a cityscape, assuming the user lives in a city. Each of the customization details, i.e., the model's faces, the model's bodies, the backgrounds, and the like, are synthesized AI-based images generated on-the-fly.

Other ways of deriving keywords/phrases for textual requests for synthesized AI-based images may also be implemented.

### 5. Base Images

Base images, such as a base product image 1B102, may be obtained using different approaches. One approach is to take photographs of a custom product under specific lighting conditions and use high-resolution, high-contrast cameras.

FIG. 1I is an example of how to obtain a base image. In this example, process 1I102 includes preparing a display of a custom product (here, a physical tote), setting up the light sources, determining ambient light levels, and other lighting conditions that are useful and favorable for depicting the product. In the depicted example, a photographer takes a picture of the tote displayed on a white-background screen. The scene is illuminated using several light sources. The light is also reflected from screen panels and the like.

Another method for obtaining a base image of a custom product may also be implemented. For example, a base image may be a synthetic image, a digital 3D model, and the like.

### 6. Generating Synthetic Backgrounds/Images Using AI

### 6.1. Requests

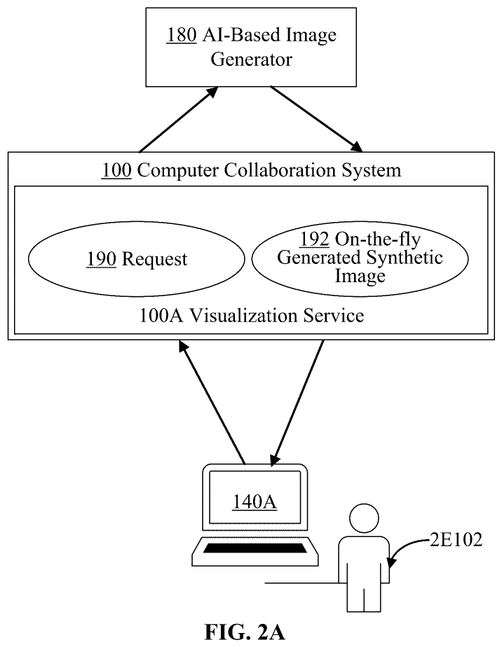

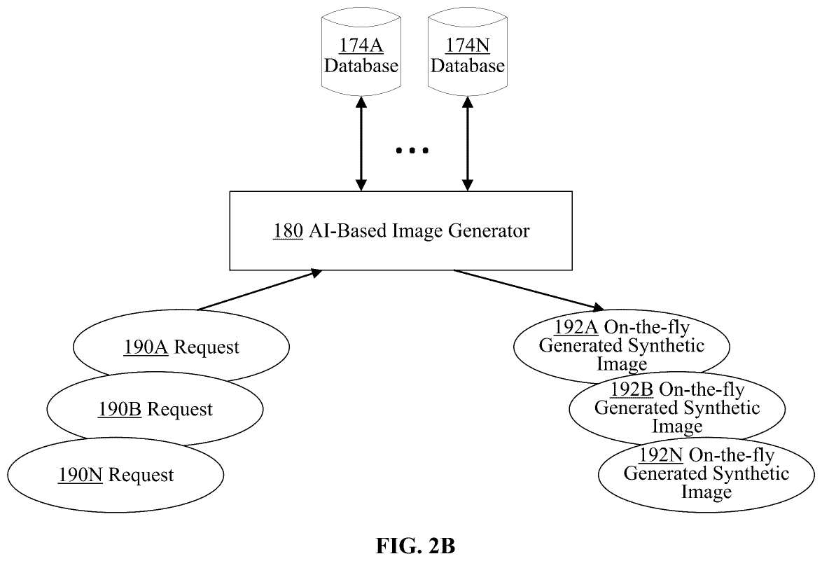

FIG. 2A is an example of utilizing an AI-based image generation approach. In the depicted example, synthetic backgrounds and images may be generated as a product of collaboration between computer collaboration system 100, AI-based image generator 180, and a user 2E102 operating a user computer 140A.

In some embodiments, computer collaboration system 100 uses its visualization service 100A to communicate with AI-based image generator 180.

User computer 140A may be used to receive customization requests from user 2E102, selections of custom products, and other requests to computer collaboration system 100. User computer 140A may also be used to display graphical visualizations of custom products, including on-the-fly-generated AI-based images that have been merged with or incorporated into the visualization of the custom products.

Computer collaboration system 100 (or its visualization service 100A) may receive a graphical representation of a custom digital product, such as a pottery product, a linen product, a card, a print, a drawing, and the like. The graphical representation for a product may include encoded information about the product, and the product description-including the key-value pairs described later.

In some embodiments, a graphical representation of the custom digital product comprises product description data. The product description data comprises a plurality of parameters of the custom digital product, and each parameter of the plurality is a key-value pair. A key-value pair is a data structure that includes an attribute key and a corresponding attribute value.

Based on the received product description, as well as the user's profile, events, and the like, visualization service 100A determines one or more regions within the depiction of the custom product. The regions will be customized when displaying the graphical representation of the custom digital product on a display device.

A region may be determined based on information in the graphical representation of the product, key-value pairs, a user's profile, and the like. The regions may include the background to be shown behind a depiction of the product, or other regions to be shown behind a depiction (or depictions) of the product or within the depiction of the product. For example, if a product is a Christmas card, then a region may be a background region displayed behind a depiction of the customized Christmas card. For example, if a product is an invitation card, one region may be displayed above a depiction of the invitation card. In contrast, another may be displayed on the invitation card itself.

For each region, visualization service 100A determines a set of keywords/phrases specific to the custom digital product and its customization. The set of phrases may include one or more key-value pairs extracted from the product description data. The set of phrases may also include one or more pieces of information extracted from a user profile of a user who customized the custom digital product. The set of phrases may further include one or more pieces of information extracted from a repository of events associated with the custom digital product. Various methods for deriving keywords/phrases were described earlier.

For each region, the corresponding keywords/phrases are used to create a request 190.

A request may be a textual request and may pertain to the particular region for which the request has been created. The request is also referred to as a synthetic image generation request. It is possible to generate multiple requests for a single region.

All the requests are transmitted by visualization service 100A to an AI-based image generator.

### 6.2. AI-Based Image Generator

AI-based image generator 180 is configured to receive requests for synthetic (or synthesized) images, generate synthetic/synthesized images in response to receiving the requests, and provide the generated synthetic/synthesized images to visualization service 200A.

FIG. 2B is an example of an AI input and a corresponding AI output to be merged with a customized image. For a given customization image, AI-based image generator 180 may receive a plurality of requests 190A, 190B, . . . 190N. The requests may pertain to a single region within the customization image; however, multiple requests may also be received for a single region.

AI-based image generator 180 may be configured to access one or more databases, such as database 174A, database 17, and so forth. A database may store SD-related files, repository images, training data, training models, learning models, and the like.

In response to receiving requests 190A-190N, AI-based image generator 180 may generate one or more on-the-fly generated synthetic images 190A-190N.

### 6.3. Syntehtic Images

Synthetic images may be generated based on the keywords/phrases included in the corresponding request. For each request, one or more synthetic images may be generated. As described before, each on-the-fly synthetic image is generated/synthesized from one or more images that have been retrieved from database(s) 174 and synthesized. Therefore, none of the 190 synthetic images look like any of the images stored in the repository.

For each request 190, upon receiving the request, AI-based image generator 180 generates a customized synthetic image based at least in part on the request and a repository of images, as described earlier. The customized synthetic image is not a copy of any image in the image repository. Instead, the customized synthetic image is generated by selecting a set of images from the image repository with an AI-based image generator and then synthesizing them using the SD approach described earlier.

A customized synthetic image may be generated by synthesizing two or more images extracted from the repository of images that are tagged with phrases matching one or more phrases in the set of phrases. Images in the repository may be tagged with corresponding tags. The customized synthetic image is generated in real time by updating the custom digital product's display on the display device. That is why they are referred to as on-the-fly-generated synthetic or synthesized images.

Referring again to FIG. 2A, once the customized synthetic images are generated by AI-based image generator 180, the generator transmits the images to the computer collaboration system 100, and the virtualization service stores the images as on-the-fly generated synthetic images 192.

Upon receiving on-the-fly-generated synthetic images 192, the visualization service 100A matches the received images to the corresponding regions, includes the images within the corresponding regions, and generates a graphical visualization of the customized product and the corresponding synthetic images.

Then, visualization service 100A displays, on the display device, the graphical visualization of the custom digital product along with the customized synthetic images in the corresponding regions.

The graphical visualization, along with the graphical representation of the custom digital product, may be transmitted or otherwise provided to a manufacturing product rendering unit of a manufacturing entity. The manufacturing product rendering unit may render a graphical visualization of the custom digital product and, for example, print it using the unit's printing instructions to generate a physical representation of the custom digital product.

### 7. Example Manufacturing System

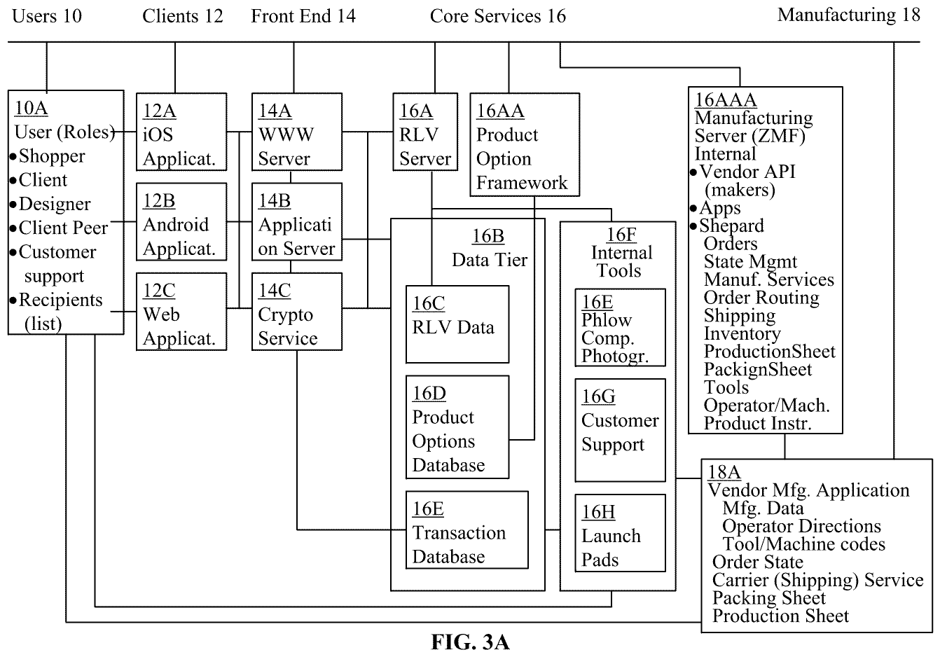

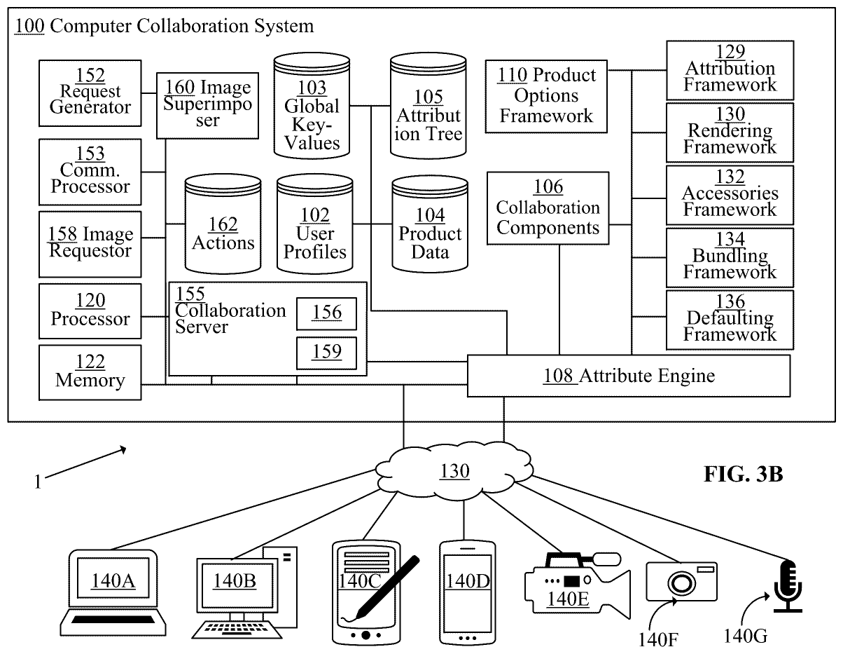

In some embodiments, an approach for using a product as a key for context-based image generation of high-quality rendering and generating manufacturing output of custom products is implemented in a product collaboration platform. The platform allows users, designers, customers, and support engineers to create digital product designs, for example. An example computing environment for creating digital designs, manufacturing products, and the like is described later in FIG. 3A.

### 7.1. Structural Description of Authoring Tools

In some implementations, a product visualization platform is configured to execute one or more software applications that generate high-quality renderings and manufacturing outputs for custom products. Generating high-quality renderings and output may involve performing several visualization and production tasks. The tasks may be performed by executing the software applications as a set of sequential and/or parallel processes. As will be explained later, the applications are also referred to as authoring applications or authoring tools.

The authoring tools may receive an initial description of a product to be displayed by the platform, after which the product becomes available for customization. From the initial description, the tools may generate layouts or manufacturing files that include a high-level representation of how the product is to be made or embellished, and which parts are customizable. The layouts and manufacturing files are described later.

Manufacturing files may also include markups, and such files may be sent to a manufacturer. A markup may be a two-color checkerboard pattern comprising a plurality of squares, where each square is a single color, and each adjacent square is the opposite color. For example, a markup may be a two-color checkerboard pattern comprising solid-colored squares, where each square is a single color, and each adjacent square is the opposite color. A markup portion of an input image may be partitioned into a set of regions, where each region of the set of regions represents a single corresponding square of the markup. In other embodiments, the markups may include different patterns, shapes, or color(s). The markups have been disclosed, for example, in U.S. Pat. Nos. 9,852,533B2 and 10,283,165 B2.

In response to the manufacturer's request to send the manufacturing files for a product, the manufacturer may generate a physical product containing the markups and send it to the platform's operators.

Upon receiving the physical product with the markups, the platform's operators may, for example, use digital cameras to capture a set of high-quality photographs of the physical product and its corresponding markups. The photographs are then provided as input to the authoring tools executing on the platform. For example, photographs containing markups may be provided as input to generate various views of the product, depicting the product with different finishes, patterns, colors, shading, and the like.

In some implementations, the visualization platform uses various views (e.g., configurable images, layouts, and design views (described later)) to depict the product and to allow generating output, which then can be, for example, displayed on the website generated by the visualization platform and made available to customers for personalization, customization, and potentially purchasing. Different views are described later.

Various depth maps and laser-based imagery may also be used. Examples of devices that capture information about a product's physical appearance or construction may include cameras, scanning devices (such as laser scanners, iPhones (Time of Flight imaging), Kinects (structured infrared light pattern), and the like. Depth maps (generated using, for example, Microsoft's Kinect hardware and laser scanners may be used as scanning devices in testing and asset production. In the context of this disclosure, they operate similarly to, for example, a camera. They may be configured to capture the product's physical attributes or surface characteristics. The depth maps and laser scans may then be used in asset generation in the authoring tool.

If a customer finishes customizing a product and, for example, places an order for it, the data describing the customized product may be transmitted to a print server. The print server may use the data to generate a manufacturing output file. The output file may contain manufacturing instructions that a manufacturer may use to produce the customized product as ordered by the customer. The manufacturing instructions are described later.

### 7.2. Designing an Asset

In some implementations, a product visualization platform is configured to run software applications that generate high-quality renderings and manufacturing outputs for custom products. The high-quality renderings may be used, for example, to generate depictions of various products and their components. The products are also referred to herein as assets. The assets may be displayed on a website or other service, where users can interact with digital files featuring the assets and personalize, customize, and order the product. Product customization may involve, for example, using high-quality renderings to display the products using the website's or the chosen display service's functionality.

However, before a high-quality rendering of an asset can be generated, the asset must be designed, and a test must be conducted to determine whether a manufacturer can produce a physical product that conforms to the designer's specifications.

### 7.3. Asset Definition Data

Asset definition data is the data that parametrically describes an asset and/or a customized product. In some implementations, the asset definition data includes the Product Description Key-Values as disclosed in, for example, U.S. patent application Ser. No. 17/458,116, U.S. patent application Ser. No. 17/501,513, U.S. patent application Ser. No. 17/387,154, U.S. patent application Ser. No. 17/384,636, U.S. patent application Ser. No. 17/501,451, U.S. patent application Ser. No. 16/867,898, and U.S. Pat. No. 11,080,912.

In addition to the Product Description Key-Values, manufacturing constraints may also be used. The manufacturing constraints may be used to define the metes and bounds of the equipment employed by manufacturers producing the products. The manufacturing instructions are usually compatible with the configurations of manufacturing servers, such as print servers, that process them and generate outputs that meet the customer's settings.

Manufacturing instructions usually capture all the information needed to produce a product customized by a user and/or a designer. The manufacturing instructions capture the key-value pairs (described in detail later) in a format understandable to the equipment deployed by the manufacturer. As will be described later, two or more customized products may have their own sets of key-value pairs; however, not all key-value pairs in the corresponding sets are the same. For example, a collection of coffee mugs with a particular floral design imprinted on them may share or have similar subsets of the key-value pairs that capture the details of that design.

Certain details of a group of customized products may be captured by a subset of key-value pairs that are specific to each customized product. That subset of the key-value pairs may be included in a so-called dictionary and labeled as reusable key-value pairs. The dictionary may be stored in a storage or a memory unit by, for example, a product customization platform, which is described later.

Similarly, one or more manufacturing constraints among a plurality of manufacturing constraints for manufacturing a group of certain customized products may be specific to every such customized product. One or more certain manufacturing constraints may be included in the dictionary and labeled as reusable manufacturing constraints.

Realistically, during conversations with a manufacturer, it might be difficult to describe the necessary manufacturing constraints in a way that ensures the manufacturer's product matches the customized product (described using the key-value pairs). Therefore, there is a need to use the dictionary with the labeled particular manufacturing instructions (corresponding to a subset of the key-value pairs), and then select a short list of the manufacturing instructions, selected from the labeled particular manufacturing instructions, and use them as a starting point to capture the characteristics of the customized product. Then the manufacturing instructions from the shortlist may be refined and further fine-tuned until the accurately manufactured product can be produced.

### 7.4. User Devices

FIG. 3A is a block diagram illustrating an example environment for product design and manufacturing. FIG. 3A depicts several examples of users 10. Each of the 10 users may use their own or a shared computer device. Examples of user devices are described later in FIG. 3B (see devices 140A-G).

In some embodiments, examples of user 10 are determined based on the roles that may be assigned to the users. Examples 10A of roles may include a shopper, a client, a designer, a client peer, a customer support engineer, a recipient, and the like.

### 7.5. Client Applications

Clients 12 in FIG. 3A refer to client applications implemented on client servers 14 and are configured to support requests received from users 10A. Non-limiting examples of clients 12 may include iOS applications 12A, Android applications 12B, Web applications 12C, and the like.

### 7.6. Frontend Servers

Frontend servers 14 are computer-based servers configured to process client requests 12 and, in many cases, interact with core services 16 to resolve them further. Examples of frontend servers 14 include one or more WWW servers 14A, one or more application servers 14B, and one or more cryptographic servers 14C. Cryptographic servers 14C may be configured to provide cryptographic services for encrypting/decrypting, transmitting, or otherwise communicating data between the entities depicted in FIG. 3A.

### 7.7. Core Services

Core services 16 in FIG. 3A refer to servers and services implemented in a role-based collaboration platform configured to provide functionalities for creating and designing digital designs, handling collaboration requests, and facilitating the customization requests received from users 10.

In some embodiments, a customization process performed by a user (user 10), intended to generate a digital design of a customized product, is captured in so-called product description data, which may then be translated into a manufacturing description comprising product and manufacturing instructions.

The product and manufacturing instructions may include digital design specifications, data, and code needed to manufacture a custom product. That may include instructions for generating, for example, a 3D geometry for digital final products. This may also include instructions for generating 2D and/or 3D patterns that may be used to cut, cast, or form physical components of physical final products. The patterns may be parametric, i.e., they may have parameters that, through encoded relationships, adjust the pattern's form to meet a specific need.

For instance, a set of 2D patterns for a t-shirt, graded by size, may become a parametric pattern by interpolating the grade curvatures. A single parametric value may set this automatic grading. The single parametric value is usually called a ‘size.’

The product instructions may also include 2D and 3D models used to form portions of a product through additive or subtractive manufacturing. The models may be parametric, i.e., they may have parameters that, through coded relationships, adjust the model's form to meet specific needs. For instance, a set of 3D models may represent a bike helmet. Each model may fit a statistically normed human head of a specific age. A coded relationship between the models may allow for interpolation of the set of models for a specific age. A single parametric value may set the automatic interpolation. The single parametric value in this case is usually called an ‘age.’

The product instructions may also include material properties, such as the physical material used to form the product from a pattern. Some material properties may be parametric, i.e., they may be selected or changed during manufacturing.

The properties may also include a body color. For instance, the color of a fabric may be selected for manufacturing a t-shirt. For another example, the color of plastic may be selected when manufacturing a bike helmet.

The properties may also include a body texture, such as the fabric weave of a t-shirt, which may be specified as smooth or stubby. For instance, the surface of a plastic bike helmet may be polished or satin. Each property is necessarily specific to each class of materials. Examples of materials and properties may include a fabric (such as a weave or knit type, a fiber type (cotton, wool, flax, polyester, polypropylene), a thread size, a thread count, a color, an integral design (knit, tapestry), a bolt width, a selvage type, a surface (hand), and the like.

The properties may also include plastics, which may include sub-properties such as color, surface quality (a bidirectional luminance function) , melting point, impact resistance, a forming method (thermoplastic, cast), a type (acrylic, polypropylene, etc.), and the like.

The properties may also include metals, which may include sub-properties such as a type (aluminum, steel, copper, brass, etc.), a color, a surface quality (e.g., a bidirectional luminance function), a melting point, a tensile strength, a shear strength, toxicity, and the like.

The properties may also include non-woven specified by a type (paper, felt, Tyvek, etc.), a color, a surface quality (e.g., a bidirectional luminance function), a surface type (hot pressed, natural, texture, etc.), a weight per square meter, an acid content, compatible media, coating, and the like.

The properties may also include metamaterials, which are combinations of multiple materials formed during a manufacturing process. For instance, during fused deposition modeling, plastics with a variety of properties may be mixed to produce a physical product with gradations in flexibility, durometer, and the like. For example, during laser sintering of metals, a mix of metal alloys with diverse properties may be deposited, resulting in a product with a gradation of metallic properties. As another example, during high-resolution UV printing, layers of UV-cured material with different refractive indices may be deposited, resulting in a wide variety of optical effects.

The properties may also include embellishments such as trim color, designs, and applied ornaments. The trim colors may indicate the edging around the sleeve of a t-shirt, the base of a bike helmet, and the like.

The designs may indicate a custom-printed front of a t-shirt, a custom thermal-printed design on the side of a bike helmet, and the like.

The applied ornaments may indicate rhinestones on a t-shirt, holographic spangles on a bike helmet, and the like.

Some properties may apply to a large class of products and may allow for a limited set of properties to be transferred from one product to another. Other properties may be specific to a particular product or manufacturing method.

It may be appreciated that much of the novel art of the system and method is in enumerating the constraints imposed by manufacturing a specific custom product and crafting these constraints as a set of product option key-value pairs. These manufacturing constraints are propagated throughout the entire system and method, and, by using these product option key-values, they enable the manufacturing of a series of custom products that meet these physical constraints.

Referring again to FIG. 3A, in some embodiments, core services 16 refer to services implemented in a role-based collaboration platform. In the depicted example, core services 16 may be provided by one or more real-view (RLV) servers 16A and a product option framework 16AA. Both RLV servers 16A and the product option framework 16AA may use one or more data-tier databases 16B, including RLV Data 16C, a product options database 16D, a transaction database 16E, and the like.

In some embodiments, core services 16 may also utilize internal tools 16F, such as a “Phlow” computational photographic tool 16E, customer support tools 16G, launch pad tools 16H, and the like.

Product option framework 16AA is also referred to as a persistent design data framework. The framework data may include a product option set comprising product options for a specific product type. It usually contains the product instructions (e.g., collaboration components 106 in FIG. 2) for manufacturing the product.

In some embodiments, product option framework 16AA is configured to provide services for transforming ProductOption key-value pairs (i.e., manufacturing constraints) from one product to the other. Transforming the ProductOption key-value pairs from one product to another may require, for example, converting the color space (e.g., sRGB to CMYK US Web Coated (SWOP) v2), converting an image from raster to vector, and/or resizing the image to fit.

An example use-case of the product option framework is described in detail in FIG. 3B.

In some embodiments, there are two basic types of product instructions: (1) fixed (that include the instructions for the product which are fixed and not customized), and (2) custom (that contain the logic to transform a user interface parameter into a product instruction).

In some embodiments, the product option set includes logic to enumerate each customizable option, thereby presenting a complete user interface for changing the parametric product instructions.

The instructions for manufacturing a customized product are usually parametric. The parameters include the size of the customized product (this can be multi-dimensional, and include width, height, depth, and the like). The parameters may also relate to human sizes or age. The parameters may also be custom and based on biometric information.

The parameters may also include a component body color, a component body texture, a trim body color, a trim body texture, a design area, and the like.

In some embodiments, a product option may be represented as a key-value pair. The key-value pair is a label that may span individual products and represent a product class. The keys of pairs may include a material type, a color, a size, and the like.

The value in a key-value pair is a specific discrete or continuous value that sets a manufacturing instruction. Examples of discrete (enumerated) values may include fabric types such as cotton, cotton-polyester blend, silk, and the like. The discrete values may also include specific colors, such as white, navy, and black.

Examples of continuous values of key-value pairs may include a single element, such a length or a ribbon, a vector, such as a size of a frame for a print (width (in inches)) or a height (in inches)), or the size of a box for the European countries, such as a size of a box for the EU (width (in millimeters), height (in millimeters), depth (in millimeters)).

The values may also reference a known file type, such as an image for the design on a t-shirt, an embroidery file for the back of a jacket, an engraving design for a bracelet, and the like.

In some embodiments, values in key-value pairs may include a set of graphic primitives for a design, such as an image, a line, a circle, a rectangle, a text, a group, and the like.

The product option key-values may have default values. Default values are pre-set values that will produce a product without changing any key-value pairs through customization. When key values are changed, they may trigger a product option framework event chain. A product option framework event chain is a journal of each key-value change ordered in time.

A product type may itself be represented by a product option key-value. Using this option type, one product type may be associated with another product type through a well-known relationship.

In some embodiments, a product option framework event chain includes one or more products and may represent or memorialize an event. The products may represent or memorialize an event. Examples of events include weddings, birthdays, anniversaries, graduations, national holidays, and reunions.

Many products fit into an event chain. For example, the products that fit into a wedding event may include the following products: save the date products, invitations, RSVPs, bachelor party invite products, bachelorette party invite products, party favors products, gift registry cards, place cards, napkins, wedding programs, wedding gifts, thank-you cards, wedding keepsake photos, and the like.

Examples of products that may fit into a birthday event include invitations, RSVPs, party bags, party keepsake photos, and the like.

In some embodiments, in a product option set event chain, a key-value pair encodes the next product in the chain. For example, an invitation may be chained to an RSVP card. A key-value pair may also encode the role for the chained event. For example, a chained RSVP card key-value may further include the invitation recipient as the sender role for the RSVP card.

A key-value pair may also encode the shared properties used to set the chained product's properties. For instance, a design for the invitation may be shared with the RSVP card. A key-value pair may also encode the timing for the chained product. Typically, event chain properties are custom (parametric) and can be adjusted by a product designer to fit a specific product set.

In an embodiment, a product option framework is configured to generate a product option framework user interface. Accordingly, each product option set is associated with logic and code to build a user interface element for each parametric product option. Furthermore, each product option set includes style hints so that each user interface element can be artfully placed to deliver a high-quality user experience.

Typically, user interface elements are designed to match each class of values found in all products covered by a product option framework. New user interface elements may be added as the product categories expand. The user interface elements may include a design view, a color editor, a font editor, a size selector, a texture selector, a text editor, a fabric swatch selector, a product configurable image, and the like.

In some embodiments, a product options framework cooperates with a user product renderer, which may be implemented, for example, in RealView server 16A. The user product renderer may be configured to render views of a custom product as though it is already manufactured. Typically, it uses a product option set of key-values as input. It creates one or more run-time assets using computational photography of the manufactured product.

### 7.8. Example Manufacturing System

Referring again to FIG. 3A, manufacturing instructions may be communicated from core services 16 to manufacturing 18, including one or more manufacturing servers 16AAA. Server 16AAA may receive the manufacturing instructions, process them, and communicate with a vendor manufacturing application 18A to generate, for example, manufacturing data, operator directions, tool/machine codes, and the like. The application may also generate information about an order state, a packing slip, a production sheet, and the like. Some of that information may be communicated to a carrier (shipping) service selected to deliver the final products to the recipients.

A final product may be manufactured using markups. A markup for, for example, a product's body color may be specified by specifying a distinct, separate color for the BodyColor key-value. A markup for a product's trim color may be specified by specifying a distinct, separate color for, for example, a TrimColor key-value pair. A markup for a product's design area may be created by specifying a marker type (e.g., a removable linear markup, a digital markup, or a digital field markup) for the design-area image.

Construction of a so-called Product RealView geometry may be performed using computational photographic techniques. For example, the color area of a surface can be recognized and layered using a custom computer graphics shader to render lighting, color, and texture. Each TrimColor area's surface may be recognized and layered using a custom computer graphics shader to render light, color, and texture. Rendering the Product RealView may be performed by setting its product option key-values and shading each of its constructed layers. 7.9. Example Manufacturing Process

As described above, a manufacturing process may pertain to both digital and physical products. Since the manufacturing instructions for a product are based on a plurality of key-value pairs for the product's digital design, in some situations the same manufacturing instructions may be used to manufacture both the digital and physical products.

In some embodiments, a product options framework (described in detail in FIG. 3C) builds an interface for a key called OutputStyle. The interface for the OutputStyle key may allow a designer (or any other collaborator) to select media values for presenting an interactive design. The choices may include a JPEG_Image, a GIF_Image, and an H264_Video.

If a designer chooses the GIF_Image option, then the product options framework may send the instructions to the manufacturing system to traverse each of the key values in the KeyValueJournal, and for each key, use a User Product Renderer to render the state of the custom physical product with that modification as images in the sRGB 32-bit RGBA format. Subsequently, the manufacturing system may store the renderings in a local image cache.

Then, the manufacturing system may iterate over the images stored in the local image cache and determine an optimal color palette for that collection.

Subsequently, the manufacturing system may convert the images in the local image cache from 32-bit RGBA format to 8-bit Indexed color.

Then, the manufacturing system may embed a digital watermark that encodes the input KeyValueJournal's UUID in the 8-bit indexed color image cache.

Next, the manufacturing system may begin encoding the image file. For example, the manufacturing system may write the header bytes; write the Logical Screen Descriptor bytes; write the found color palette as a GIF Global Color Table; write the GIF 8-bit character application name; and embed metadata as a comment (or a watermark) which encodes the input KeyValueJournal's UUID.

Next, the manufacturing system sets FrameCount to 1 and processes each frame in the image file. The processing includes checking whether there is an image in the 8-bit indexed color image cache; if so, the manufacturing system continues; otherwise, the manufacturing system proceeds to the next image.

To continue, the manufacturing system writes the GIF Graphic Control Description for the FrameCount, then processes the first 8-bit indexed-color image cache into blocks of 255 LZW-compressed bytes.

Next, the manufacturing system writes the compressed bytes and removes the first image from the 8-bit indexed color image cache. Then, the manufacturing system increments the FrameCount and repeats the process for the next frame.

Once the manufacturing system processes all frames, it writes the file terminator (such as an ASCII code for zero) to the image file and outputs the manufactured GIF product.

At this point, execution of the manufacturing instructions ends, and the product is completed.

### 8. Example Product Collaboration Platform

In some embodiments, the approach presented herein is implemented in one or more computer systems that host a product collaboration platform. Alternatively, the approach may be implemented in one or more computer systems that communicate with the collaboration platform but that do not actually host the platform itself. For the clarity of the description, it is assumed that the computer environment supporting the approach presented herein is implemented in the product collaboration platform.

FIG. 3B is a block diagram showing an example of a role-based collaboration platform. In the example depicted in FIG. 3B, a computer collaboration system 100 includes a user profiles database 102, a global-key-values database 103, a product data definitions database 104, an attribution trees database 105, collaboration components 106, a product options framework 110, an attribute engine 108, one or more processors 120 or more memory units 122, and one or more frameworks 129-136.

Furthermore, computer collaboration system 100 includes a collaboration server 155 (including a monitoring system 156 and a request analyzer 159), one or more blacklist databases 163, one or more actions databases 162, a request generator 152, a communications processor 153, and an image requestor 158, and an image superimposer 160. Computer collaboration system 100 may communicate directly or via one or more communication networks 130 with one or more user computers 140A-140G, all of which are described in detail later.

Computer collaboration system 100 shown in FIG. 3B is provided herein to illustrate clear examples and should not be considered limiting in any way. Other computer collaboration systems may include additional components, such as servers, various input/output devices, and software and/or hardware not depicted in FIG. 3C. Other computer collaboration systems may be implemented in cloud-based systems, distributed computer networks, and the like. Other computer collaboration systems may include fewer components than the example computer collaboration system 100 shown in FIG. 3B.

Certain components depicted in FIG. 3B are also described in U.S. patent application Ser. No. 18/120,402. The components, such as request generator 152, image requestor 158, and image superimposer 160, were described above.

### 9. Example Flow Chart

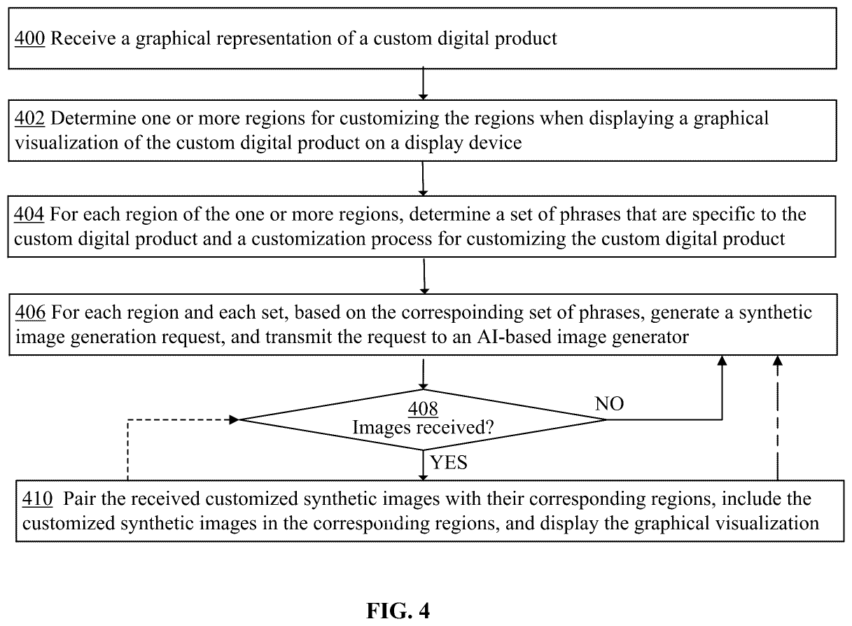

FIG. 4 is a flow chart depicting an example process for using a product as a key for context-based image generation. The method may be performed by a computer collaboration system 100, or its visualization service 100A. Both the computer collaboration system and the visualization service are configured to communicate with AI-based image generator 180 and to request and receive synthetic AI-based images. For simplicity of the description, it is assumed that the below steps are performed by the visualization service.

In step 400, a visualization service of a computer collaboration system receives a graphical representation of a custom digital product. A graphical representation of the custom digital product may be constructed using a series of rendering and compositing actions derived from product description data for custom digital product.

The compositing actions include manufacturing instructions. The product description data comprise a plurality of parameters of the custom digital product. Each parameter, of the plurality of parameters of the custom product, is a key-value pair. A key-value pair is a data structure that includes an attribute key and a corresponding attribute value.

In step 402, the visualization service determines one or more regions for customizing a region when displaying the graphical representation of the custom digital product on a display device.

In step 404, the visualization service, for each region of the one or more regions, determines a set of phrases that are specific to the custom digital product and a customization process for customizing the custom digital product.

A set of phrases comprises one or more key-value pairs extracted from the product description data. The set of phrases may also include one or more pieces of information extracted from a user profile of a user who customized the custom digital product. The set of phrases may also include one or more pieces of information extracted from a repository of events associated with the custom digital product.

In step 406, for each region and based on the corresponding set of phrases, the visualization service generates a synthetic image generation request. Also in this step, the visualization service transmits the synthetic image generation request to an artificial intelligence (AI) based image generator configured to generate synthetic images.

Transmitting the requests to the AI-based image generator causes the AI image generator to generate, for each region and each request for the region, a customized synthetic image based on, at least in part, the synthetic image generation request and a repository of images. None of the customized synthetic images is a copy of any image from the repository of images. Then, the AI image generator transmits the customized synthetic image to the computer collaboration system.

A customized synthetic image is generated by synthesizing two or more images extracted from the repository of images that are tagged with phrases matching one or more phrases in the set of phrases. Images in the repository of images are tagged using corresponding tags. The customized synthetic image is generated contemporaneously by updating a display of the custom digital product on the display device.

In step 408, the visualization service check if any of the synthetic images have been received from the AI image generator in response to the sent requests. If the images have been received, then the visualization service proceeds to step 410. Otherwise, the visualization service continues checking in step 406.

In step 410, the visualization service pairs the received customized synthetic images with their corresponding regions and includes the customized synthetic image in the corresponding region.

Also in this step, the visualization service causes displaying, on the display device, a graphical visualization of the custom digital product along with the customized synthetic images included in the corresponding regions.

In addition, if some of the expected customized synthetic images have not been received, the visualization service may either await such images in step 408, regenerate a request (or requests), or end the process.

### 10. Implementation Example

Although the flow diagrams of the present application depict a particular set of steps in a particular order, other implementations may use fewer or more steps, in the same or different order, than those depicted in the figures.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

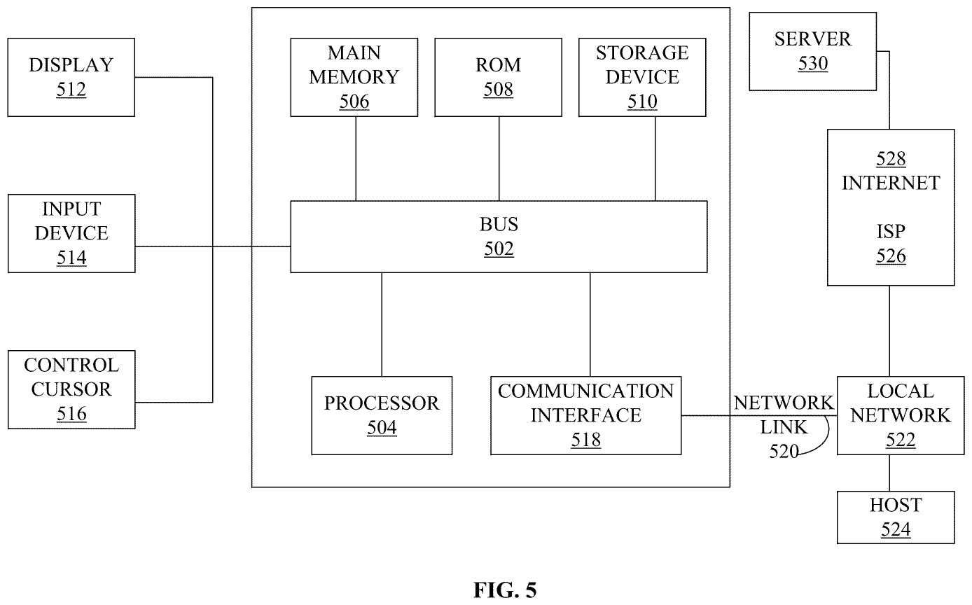

FIG. 5 is a block diagram depicting an example computer system 500 on which embodiments may be implemented. Computer system 500 includes a bus 502 or other communication mechanism for communicating information, and a processor 504 coupled with bus 502 for processing information. Computer system 500 also includes a main memory 506, such as random-access memory (RAM) or another dynamic storage device, coupled to bus 502 for storing information and instructions to be executed by processor 504. Main memory 506 may also be used to store temporary variables or other intermediate information during the execution of instructions by processor 504. Computer system 500 further includes a read-only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. Although bus 502 is illustrated as a single bus, bus 502 may comprise one or more buses. For example, bus 502 may include, without limitation, a control bus by which processor 504 controls other devices within computer system 500, an address bus by which processor 504 specifies memory locations of instructions for execution, or any other type of bus for transferring data or signals between components of computer system 500.

An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allow the device to specify positions in a plane.

Computer system 500 may implement the techniques described herein using customized hard-wired logic, one or more ASICs or FPGAs, firmware and/or program logic, or computer software which, in combination with the computer system, causes or programs computer system 500 to be a special-purpose machine. According to one embodiment, those techniques are performed by computer system 500 in response to processor 504 executing one or more sequences of instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the embodiments. Thus, embodiments are not limited to any specific combination of hardware circuitry and software.

The term “computer-readable medium” as used herein refers to any medium that participates in providing data that causes a computer to operate in a specific manner. In an embodiment implemented using computer system 500, various computer-readable media are used, for example, to provide instructions to processor 504 for execution. Such a medium may take many forms, including but not limited to, non-volatile media and volatile media. Non-volatile media includes, for example, optical or magnetic disks, such as storage device 510. Volatile media includes dynamic memory, such as main memory 506. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip, or memory cartridge, or any other medium from which a computer can read.

Various forms of computer-readable media may be used to carry one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive data over the telephone line and use an infrared transmitter to convert it into an infrared signal. An infrared detector can receive the data carried in the infrared signal and appropriate circuitry can place the data on bus 502. Bus 502 transfers data to main memory 506, from which processor 504 retrieves and executes instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem that provides a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication to and from other data devices over one or more networks. For example, network link 520 may provide a connection through local network 522 to a host computer 524 or to data equipment operated by an Internet Service Provider (ISP) 526. ISP 526, in turn, provides data communication services through the worldwide packet data communication network, now commonly referred to as the “Internet” 528. Local network 522 and Internet 528 both use electrical, electromagnetic, or optical signals that carry digital data streams.

Computer system 500 can send messages and receive data, including program code, through the network(s), network link 520, and communication interface 518. In the Internet example, server 530 might transmit a requested code for an application program through Internet 528, ISP 526, local network 522, and communication interface 518. The received code may be executed by processor 504 as it is received, and/or stored in storage device 510, or other non-volatile storage for later execution.

In the foregoing specification, embodiments have been described with reference to numerous specific details that may vary from implementation to implementation. Thus, the sole and exclusive indicator of what is, and is intended by the applicants to be, the approach is the set of claims that are issued from this application, in the specific form in which such claims are issued, including any subsequent correction. Hence, no limitation, element, property, feature, advantage, or attribute that is not expressly recited in a claim should limit the scope of such claim in any way. The specification and drawings are, accordingly, to be regarded in an illustrative rather than a restrictive sense.

What is claimed is:

1. A method for using a custom product as a key for context-based image generation, the method comprising:
determining, by a visualization service, one or more regions for customizing regions when displaying a graphical visualization of a custom product on a display device;
for a region of the one or more regions:
determining, by the visualization service, a set of phrases that are specific to the custom product;
wherein the set of phrases comprises one or more pieces of information extracted from a user profile of a user who customized the custom product;
based on the set of phrases, generating a synthetic image generation request;
transmitting the synthetic image generation request to an artificial intelligence (AI) based image generator configured to generate synthetic images;
causing the AI-based generator to:
generate a customized synthetic image based on, at least in part, the synthetic image generation request and a repository of images;
including the customized synthetic image in the region;
causing the display device to display the graphical visualization of the custom product along with the customized synthetic image in the region.

2. The method of claim 1, wherein the graphical representation of the custom product is constructed using a series of rendering and compositing actions derived from product description data for a custom product;
wherein the customized synthetic image is not a copy of any image from the repository of images;
wherein the compositing actions include manufacturing instructions.

3. The method of claim 2, wherein the set of phrases comprises one or more key-value pairs extracted from the product description data.

4. The method of claim 2, wherein the product description data comprise a plurality of parameters of the custom product;
wherein each parameter, of the plurality of parameters of the custom product, is a key-value pair;
wherein the key-value pair is a data structure that includes an attribute key and a corresponding attribute value.

5. The method of claim 2, wherein the set of phrases comprises one or more pieces of information extracted from a repository of events associated with the custom product.

6. The method of claim 2, wherein the customized synthetic image is generated by synthesizing two or more images extracted from the repository of images that are tagged with phrases matching one or more phrases in the set of phrases;
wherein images in the repository of images are tagged using corresponding tags;
wherein the customized synthetic image is generated contemporaneously by updating a display of the custom product on the display device.

7. The method of claim 1, further comprising:
transmitting the graphical representation of the custom product to a manufacturing product rendering unit;
causing the manufacturing product rendering unit to:
render the graphical representation of the custom product;
print, using one or more printing instructions of a manufacturing product rendering unit, the graphical representation of the custom product to generate a physical representation of the custom product.

8. One or more non-transitory computer-readable media storing one or more instructions, which, when executed by one or more processors, cause the one or more processors to perform:
determining, by a visualization service, one or more regions for customizing regions when displaying a graphical visualization of a custom product on a display device;
for a region of the one or more regions:
determining, by the visualization service, a set of phrases that are specific to the custom product;
wherein the set of phrases comprises one or more pieces of information extracted from a user profile of a user who customized the custom product;
based on the set of phrases, generating a synthetic image generation request;
transmitting the synthetic image generation request to an artificial intelligence (AI) based image generator configured to generate synthetic images;
causing the AI-based generator to:
generate a customized synthetic image based on, at least in part, the synthetic image generation request and a repository of images;
including the customized synthetic image in the region;
causing the display device to display the graphical visualization of the custom product along with the customized synthetic image in the region.

9. The one or more non-transitory computer-readable media of claim 8, wherein the graphical representation of the custom product is constructed using a series of rendering and compositing actions derived from product description data for a custom product;
wherein the customized synthetic image is not a copy of any image from the repository of images;
wherein the compositing actions include manufacturing instructions.

10. The one or more non-transitory computer-readable media of claim 9, wherein the set of phrases comprises one or more key-value pairs extracted from the product description data.

11. The one or more non-transitory computer-readable media of claim 9, wherein the customized synthetic image is generated by synthesizing two or more images extracted from the repository of images that are tagged with phrases matching one or more phrases in the set of phrases;
wherein images in the repository of images are tagged using corresponding tags;
wherein the customized synthetic image is generated contemporaneously by updating a display of the custom product on the display device.

12. The one or more non-transitory computer-readable media of claim 9, wherein the set of phrases comprises one or more pieces of information extracted from a repository of events associated with the custom product.

13. The one or more non-transitory computer-readable media of claim 9, wherein the customized synthetic image is generated by synthesizing two or more images extracted from the repository of images that are tagged with phrases matching one or more phrases in the set of phrases;
wherein images in the repository of images are tagged using corresponding tags;
wherein the customized synthetic image is generated contemporaneously by updating a display of the custom product on the display device.

14. The one or more non-transitory computer-readable media of claim 8, further comprising:
transmitting the graphical representation of the custom product to a manufacturing product rendering unit;
causing the manufacturing product rendering unit to:
render the graphical representation of the custom product;
print, using one or more printing instructions of a manufacturing product rendering unit, the graphical representation of the custom product to generate a physical representation of the custom product.

15. A custom product computer system generator comprising:
a memory unit;
one or more processors; and
a custom product computer storing one or more instructions, which, when executed by one or more processors, cause the one or more processors to perform:
determining, by a visualization service, one or more regions for customizing regions when displaying a graphical visualization of a custom product on a display device;
for a region of the one or more regions:
determining, by the visualization service, a set of phrases that are specific to the custom product;
wherein the set of phrases comprises one or more pieces of information extracted from a user profile of a user who customized the custom product;
based on the set of phrases, generating a synthetic image generation request;
transmitting the synthetic image generation request to an artificial intelligence (AI) based image generator configured to generate synthetic images;
causing the AI-based generator to:
generate a customized synthetic image based on, at least in part, the synthetic image generation request and a repository of images;
including the customized synthetic image in the region;
causing the display device to display the graphical visualization of the custom product along with the customized synthetic image in the region.

16. The custom product computer system generator of claim 15, wherein the graphical representation of the custom product is constructed using a series of rendering and compositing actions derived from product description data for a custom product;
wherein the customized synthetic image is not a copy of any image from the repository of images;
wherein the compositing actions include manufacturing instructions.

17. The custom product computer system generator of claim 16, wherein the set of phrases comprises one or more key-value pairs extracted from the product description data.

18. The custom product computer system generator of claim 16, wherein the product description data comprise a plurality of parameters of the custom product;
wherein each parameter, of the plurality of parameters of the custom product, is a key-value pair;
wherein the key-value pair is a data structure that includes an attribute key and a corresponding attribute value.

19. The custom product computer system generator of claim 16, wherein the set of phrases comprises one or more pieces of information extracted from a repository of events associated with the custom product.

20. The custom product computer system generator of claim 16, wherein the customized synthetic image is generated by synthesizing two or more images extracted from the repository of images that are tagged with phrases matching one or more phrases in the set of phrases;
wherein images in the repository of images are tagged using corresponding tags;
wherein the customized synthetic image is generated contemporaneously by updating a display of the custom product on the display device.
